(19) United States
(12) Patent Application Publication
(10) Pub. No.: US 2007/0160407 A1
(43) Pub. Date: Jul. 12, 2007

(54) PRINTER

(75) Inventors: Kazutaka Suzuki, Fukushima-ken (JP); Hiroyuki Murayama, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/617,493

(22) Filed: Dec. 28, 2006

(30) Foreign Application Priority Data
Jan. 6, 2006 (JP) 2006-001470

(51) Int. Cl. B41J 13/00; B41J 11/04

(52) U.S. Cl. 400/578

(57) ABSTRACT

A printer is provided. The printer includes a platen that is operative to rotate and support a forwarded recording medium. A plurality of recording units are operative to freely move in contacting and separating directions about the platen and perform a printing operation in contact with the recording medium. A controller is operative to change a moving speed from the start of movement toward the platen and to the abutment to the recording medium in the recording units.

This patent document claims benefit of Japanese Patent Application No. 2006-001470 filed on Jan. 6, 2006, which is hereby incorporated by reference.

### BACKGROUND

1. Field

The present embodiments relate to a printer.

2. Related Art

Generally, a thermal printer, for example, a color printer thermally transfers ink to a recording medium using a plurality of ink ribbons and thermal heads. Thermal printers are widely used as a form of a color printers, which records a variety of ink in the recording medium.

As shown in FIG. 4, a known thermal printer 101 includes a roller-shaped platen 103 and four thermal transfer type recording units 104 disposed in a circumferential direction of the platen 103. Each recording unit 104 has a thermal head 104a facing the platen 103 and an ink ribbon 104b of each color mounted on each recording unit 104 to be interposed between the platen 103 and the thermal head 104. The recording unit 104 can freely move in contacting and separating directions ZD about the platen 103. In the known thermal printer 101, a recording medium 110 forwarded in a predetermined forwarding direction FD is interposed between the platen 103 and the ink ribbon 104b. The plural recording units 104 move in a direction (hereinafter, referred to as ‘approaching direction’) adjacent to the platen 103 from the recording unit on an upstream side sequentially, and the ink ribbon 104b abuts on the recording medium 110. Ink of the ink ribbon 104b is thermally transferred to the recording medium 110 by heating the thermal head 104a.

In the known thermal printer 101, occurrence of displacement of location or blank portion, for example, a jitter (recording stain) is prevented by correcting the energization starting timing of the thermal head 104a disposed on a downstream side on the basis of the driving capability of a stepping motor (not shown) rotating the platen 103 and the energization starting timing of the thermal head 104a disposed on an upstream side (see Patent Document 1).

[Patent Document 1] Japanese Unexamined Patent Application Publication No. 2003-251840

As shown in FIG. 5, the recording unit 104 abuts on the recording medium 110, and the recording medium 110 impacts the platen 103 at T1. The forwarding speed V0 of the recording medium 110 and the rotation speed of the platen are reduced. Since the stepping motor driving the platen 103 changes a driving force thereof to recover the reduced rotation speed to a predetermined rotation speed, there is a problem that the forwarding V0 of the recording medium 110 is varied within a range of V0±α. A recording unit 104 disposed on the upstream side of the recording unit 104 abutting on the recording medium 110 generates the jitter, thereby deteriorating printed images or characters.

The known printer 101 forwards the recording medium 110 at a high speed of about 2.4 ips (about 61 mm/s). In view of the foregoing, a predetermined moving speed from the start of movement to the abutment of the recording unit 104 is reduced to a moving speed at which an impact is not given to the recording medium 110 and the platen 103, the recording unit may be deviated from a recording location (for example, a location where each color is overlapped) on the recording medium 110 at the time of the abutment of the recording unit 104 and the jitter may occur. Therefore, there is a problem that the moving speed of the recording unit 104 may not be reduced to a moving speed at which the impact is not generated.

### SUMMARY

The present embodiments may obviate one or more of the limitations or drawbacks of the related art. For example, in one embodiment, a printer can suppress and prevent a jitter (recording stain), which may occur at the time of the abutment of a recording unit without a remarkable variation in predetermined moving speed from the start of movement and to the abutment to the recording medium of the recording unit.

In one embodiment, a printer includes a platen that rotates while supporting a forwarded recording medium. A plurality of recording units freely move in contacting and separating directions about the platen and performing a printing operation in contact with the recording medium. A controller performs a control operation of changing a moving speed from the start of movement toward the platen and to the abutment to the recording medium in the recording units in two steps or more, and reduces the moving speed at the time of the abutment to the recording medium lower than the moving speed from the time point before the abutment to the recording medium among the moving speeds.

In one embodiment, the controller reduces the moving speed at the time of the abutment of the recording unit to the recording medium to a moving speed at which the recording medium does not have a delay in forwarding speed.

In one embodiment, the moving speed is adjusted by quickly moving the recording unit when the recording unit is separated from the recording medium, and by moving the recording unit slowly when the recording unit approaches or abuts on the recording unit. In this embodiment, it is possible to reduce an impact given to the recording medium and the platen by the recording unit without a remarkable variation in predetermined moving speed from the start of movement and to the abutment to the recording medium of the recording unit. In this embodiment, the occurrence of a jitter (recording stain) is suppressed, and thus improves the recording quality of images or characters.

In one embodiment, the impact generating the delay to the recording medium and the platen is prevented without a remarkable variation in predetermined moving speed from the start of movement and to the abutment to the recording medium of the recording unit. In this embodiment, the jitter does not occur and the recording quality of the images or the characters recorded in the recording medium are improved.

### BRIEF DESCRIPTION OF THE DRAWINGS

FIG. 1 is a side view of one embodiment of a printer.

FIG. 2 is a conceptual view showing one embodiment of a cam unit of a recording unit and a moving status thereof in a printer.

FIG. 3 is a conceptual view showing one embodiment of a moving status of a recording unit in a printer.

FIG. 4 is a side view showing a known thermal printer.

FIG. 5 is a graph showing a variation of the forwarding speed with time of a recording medium forwarded in a known thermal printer.

### DETAILED DESCRIPTION

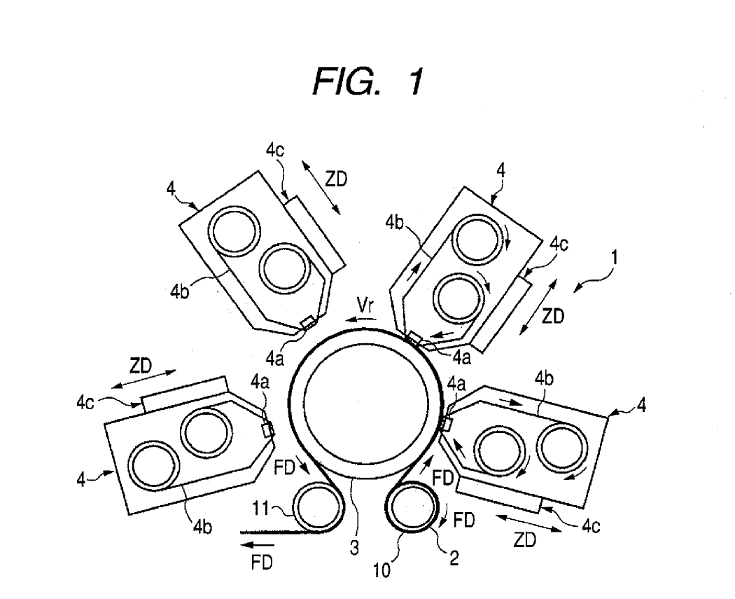

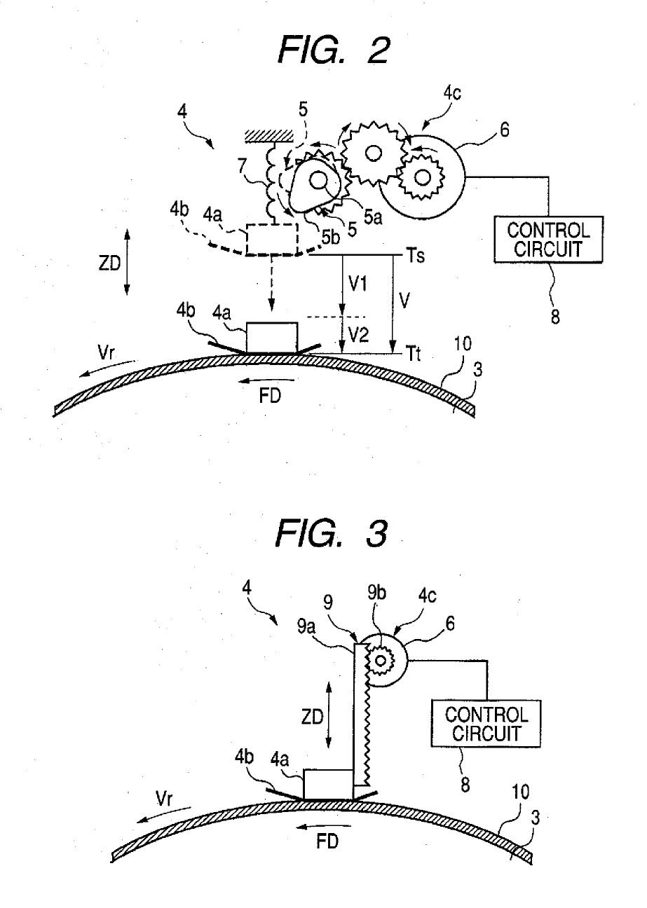

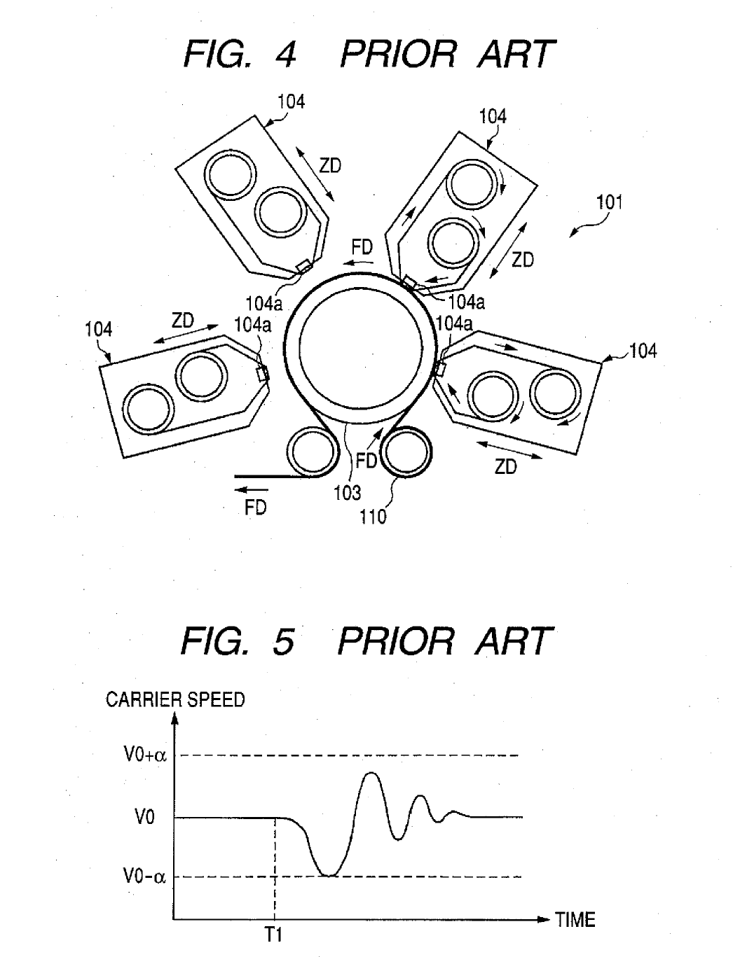

In one embodiment, as shown in FIG. 1, a printer 1 includes a feed roller 2, a platen, 3, a discharge roller 11 four recording units 4, and a control circuit (shown only in FIG. 2) in a case (not shown) of the printer 1.

In one embodiment, the feed roller 2 and the discharge roller 11 have roll widths larger than the width of a roll paper 10. The feed roller 2 and the discharge roller 11 rotate to feed or discharge the roller paper 10 in a predetermined forwarding direction FD by using respective stepping motors (not shown). The roll paper 10 is rolled onto the feed roller 2. A cutter (not shown), which cuts the roll paper 10 is disposed on the downstream side of the discharge roller 11 in a forwarding direction FD.

In one embodiment, the platen 3 is formed in a roller shape. The platen 3 has a diameter suitable for disposing four recording units 4 by facing each other and the roll width larger than the width of the roll paper 10. The platen 3 is disposed between the feed roller 2 and the discharge roller 11 in a forwarding path of the roll paper 10. The roll paper 10 has a substantially horseshoe (Ω) shape and is disposed in close contact with the surface of the platen 3. The platen 3 rotates to forward the roll paper 10 in the predetermined forwarding direction FD by using a separate stepping motor (not shown).

As the recording unit 4 is used thermal transfer type recording units 4, which have ink ribbons 4b including one of inks having four colors of yellow, magenta, cyan, and black, and thermal heads 4a. The four recording units 4 are disposed in parallel in the circumferential direction of the platen so that each thermal head 4a faces the platen 3. As shown in FIG. 2, the four recording units 4 intermittently move in contacting and separating directions ZD by a cam unit 4c including a plate cam 5 having an substantially eggshell-shaped end face pushing out the whole recording units 4 or the thermal heads 4a in the approaching direction, a cam shaft motor 6 rotating a cam shaft 5a on which the plate cam 5 is mounted, and a spring 7 biasing the whole recording units 4 or the thermal heads 4a to a direction (hereinafter, referred to as ‘a separating direction’) separated from the platen 3. The plate cam 5 is control means for controlling the moving speed of the recording unit 4 in contacting and separating directions. It is preferable that the plate cam 5 has a mechanically smooth top portion 5b of a cam mountain when the recording unit 4 abuts on the platen 3.

In one embodiment, a control circuit 8 includes a arithmetic processing unit, for example, a CPU and a storage unit such as a memory. The control circuit 8 is connected to respective stepping motors of the feed roller 2, the discharge roller 11 and the platen 3, as shown in FIG. 1 or the recording unit 4 (not shown), and the control circuit 8 is used as a controller.

In one embodiment, the control circuit 8 controls the rotation speed of each stepping motor. As shown in FIG. 2, by the rotation speed of the cam shaft motor 6 of the recording unit 4, the control circuit 8 controls the moving speed (hereinafter, referred to as ‘a moving speed of a separating side’) V1 of a separating side of the recording unit 4 and the moving speed (hereinafter, referred to as ‘a moving speed of an approaching side’) V2 of an approaching side of the recording unit 4 to the roll paper 10 separately, and controls the moving speed of the recording unit 4 so that the moving speed V2 of the approaching side is lower than the moving speed V1 of the separating side.

In one embodiment, as shown in FIG. 1, the roller paper 10 is forwarded in a predetermined forwarding direction FD by the rotations of the feed roller 2, the platen 3 and the discharge roller 11. The roll paper 10 is in close contact with a surface of the platen 3 by controlling the rotation speed of the feed roller 2 and the discharge roller 11, the roll paper 10, the four recording units 4 abut on the roll paper 10 one by one from the recording unit 4 disposed on the most upstream side in the forwarding direction FD, at a predetermined speed. The recording units 4 abutting on the roll paper 10 heats the thermal head 4a and melts the ink ribbon 4b. The recording unit 4 performs the thermal transfer operation (printing operation).

In one embodiment, as shown in FIG. 2, the predetermined speed is an average moving speed V from the start of movement Ts to the abutment to the roll paper 10 Tt in the recording unit 4. The average moving speed V is the average speed of the moving speed V1 of a separating side and the moving speed V2 of an approaching side.

In one embodiment, the moving speed V2 of the approaching side is controlled to be lower than the moving speed V1 of the separating side by the control circuit 8. Since an impact to which the recording unit 4 gives to the roll paper 10 at the time of the abutment of the recording unit 4 Tt is proportional to the moving speed of the recording unit 4, the moving speed V2 of the approaching side is reduced. Therefore, the impacts to which the four recording units 4 give to the roll paper 10 and the platen 3 can be reduced.

In one embodiment, the moving speed V1 of the separating side and the moving speed V2 of the approaching side can be controlled separately. In this embodiment, it is possible to set the average moving speed V to an optimum moving speed corresponding to a forwarding speed Vr of the roll paper 10 by decreasing the moving speed V2 of the approaching side and increasing the moving speed V1 of the separating side. As the result, when the recording unit 4 abuts on the roll paper 10, the deviation from the recording unit 4 due to a time mismatch does not occur. Accordingly, the occurrence of the jitter can be suppressed without a remarkable variation in predetermined moving speed from the start of movement Ts and to the abutment to the recording medium Tt of the recording unit, and the recording quality of the images or the characters recorded in the roll paper 10 are improved.

In one embodiment, the moving speed V2 of the approaching side can be controlled separately by the control circuit 8. In this embodiment, the moving speed V2 of the approaching side is controlled to be reduced to a moving speed at which the moving speed V2 does not give a delay to the forwarding speedVr of the roll paper 10. For example, when the forwarding speed Vr of the roll paper 10 is 2.4 ips (about 61 mm/s), it is preferable that the moving speed V2 of the approaching side is controlled to be about 1/10 times (0.24 ips less than the forwarding speed Vr. Accordingly, since the occurrence of the jitter can be suppressed without a remarkable variation in predetermined moving speed from the start of movement Ts and to the abutment to the recording medium Tt of the recording unit, the recording quality of the images or the characters recorded in the roll paper 10 is improved.

For example, the moving speed is adjusted by increasing the moving speed V1 of the separating side of the recording unit 4 when the recording unit 4 is separated from the roll paper 10, and by decreasing the moving speed V2 of the approaching side of the recording unit 4 when the recording unit 4 approaches or abuts on the roller paper 10. As the result, since the occurrence of the jitter (recording stain) can be suppressed or prevented without a remarkable variation between the average moving speed V from the start of movement Ts to the abutment of the roll paper 10 Tt in the recording unit 4, and a moving speed of the known recording unit 4, the recording quality of the images or the characters recorded in the roll paper 10 is improved.

The present invention is not limited to the embodiments described above, but may be variously changed as necessary. For example, a moving speed V of the recording unit 4 is changed in two steps (the moving speed V1 of the separating side and the moving speed V2 of the approaching side). Alternatively, in the printer according another embodiment, the moving speed V may be changed in two steps or more (for example, three steps, multiple steps, infinite step (a step of diverging the number of steps to the infinity)).

In another embodiment, the recording unit 4 includes the cam unit 4c. Alternatively, as shown in FIG. 3, in the printer according to another embodiment of the invention, there may be provided in the recording unit 4 is provided a rack pinion mechanism unit 9 which includes a rack 9a mounted on the thermal head 4a and a pinion 9b mounted on the motor 6 instead of the cam mechanism unit 4c.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

What is claimed is:

1. A printer comprising:
a platen that is operative to rotate and support a forwarded recording medium;
a plurality of recording units that are operative to freely move in contacting and separating directions about the platen and perform a printing operation in contact with the recording medium; and
a controller that is operative to change a moving speed from the start of movement toward the platen to the abutment of the recording medium.

2. The printer according to claim 1, wherein the controller is operative to reduce the moving speed at the time of the abutment to the recording medium lower than the moving speed from the time point before the abutment to the recording medium among the moving speeds.

3. The printer according to claim 1, wherein the controller performs a control operation of reducing the moving speed at the time of the abutment of the recording unit to the recording medium to a moving speed at which the recording medium does not have a delay in forwarding speed.

4. The printer according to claim 2, wherein the controller performs a control operation of reducing the moving speed at the time of the abutment of the recording unit to the recording medium to a moving speed at which the recording medium does not have a delay in forwarding speed.

5. The printer according to claim 1, wherein the controller is operative to change a moving speed from the start of movement toward the platen and to the abutment to the recording medium in the recording units in two steps or more.

6. The printer according to claim 2, wherein the controller is operative to change a moving speed from the start of movement toward the platen and to the abutment to the recording medium in the recording units in two steps or more.

7. A method for operating a printer, the method comprising:
rotating a platen, which forwards a roller paper;
abutting a recording unit on the roller paper;
heating the recording head; and
changing a moving speed from the start of a movement toward the platen and to the abutment to the recording medium in the recording units.

8. The method for operating a printer, further comprising: reducing the moving speed at the time of the abutment to the recording medium lower than the moving speed from the time point before the abutment to the recording medium among the moving speeds.
